(19) United States
(12) Patent Application Publication
(10) Pub. No.: US 2006/0108858 A1
(43) Pub. Date: May 25, 2006

(54) Wheel and a bicycle equipped with such wheel

(75) Inventors: Jean-Pierre Mercat, Chavanod (FR); Jean-Marc Hillairet, Nevers (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 11/286,289

(22) Filed: Nov. 25, 2005

Related U.S. Application Data
(63) Continuation of application No. PCT/FR04/01312, filed on May 27, 2004.

(30) Foreign Application Priority Data
May 28, 2003 (FR) 03.06547

(51) Int. Cl. B06B 3/00

(52) U.S. Cl. 301/79

(57) ABSTRACT

A bicycle that includes front and rear single-arm forks enabling the front and rear wheels to be mounted and demounted from the frame of the bicycle without necessitating the removal or repositioning of a transmission element, such as a chain, or the brake, if the bicycle is so equipped, each of the wheels including at least one flexibly and compressively rigid element connecting the central hub and the rim, such elements being asymmetrical with respect to a radial median plane defined by the rim, so that the hubs of the wheels are axially off-centered in relation to the radial median plane of the rim, while the radial median plane of the rims coincides with the general median plane of the frame. The invention is also directed to the wheel of the bicycle.

### CROSS-REFERENCE TO RELATED APPLICATIONS

This application is a continuation of PCT International Patent Application No. PCT/FR2004/001312, filed on May 27, 2004, the disclosure of which is hereby incorporated by reference thereto in its entirety, and the priority of which is claimed under 35 U.S.C. §120, pursuant to the provisions of 35 U.S.C. §363.

This application claims priority under 35 U.S.C. §119 of French Patent Application No. 03.06547, filed on May 28, 2003, the disclosure of which is hereby incorporated by reference thereto in its entirety.

### BACKGROUND OF THE INVENTION

1. Field of the Invention

The invention relates to a bicycle and to a wheel to be used on such a bicycle.

2. Description of Background and Relevant Information

A traditional bicycle includes a frame, front and rear wheels, a transmission assembly, a steering assembly, and usually a braking assembly.

Currently, there are standards used for reference by manufacturers in making their bicycles.

A first standard relates to the diameter of the wheels. These standards follow the ETRTO and JIS standards that define the rim bead seat, i.e., the diameter of the rim in the area of the tire bead. Thus, 20 inch wheels are known to be used for BMX-type bikes, 26 inch wheels for all-terrain bikes, and 700 millimeter (mm) wheels for road bicycles.

Currently commercially available multipurpose bicycles have wheels which, as the case may be, most often comply with the “road” or “all-terrain” standards.

The 700 millimeter diameter for road bicycles goes back to the beginning of the previous century. It was determined as a function of the then existing road conditions, and has not been seriously reconsidered since then.

However, a wheel having a large diameter does not offer the best compromise for a multipurpose bicycle. Indeed, its weight and inertia are relatively substantial.

Another construction standard relates to the fastening of the wheels on the frame. Usually, the hubs have a width of 100 millimeters at the front, 130 millimeters at the rear for a road bike, and 100 and 135 millimeters for an all-terrain bike.

This width includes the hub, the brake disk, if present, and the sprocket cassette for the rear wheel. As a result, the rotary portion of the wheel tends to be reduced lengthwise due to the reduction of the dish of the wheel, which is not favorable for the rigidity of the wheel.

Another problem that arises for a bicycle relates to its transportation and storage. Bicycles are increasingly carried in the trunk of a car, or the rear of a SUV, for example, when the cyclist drives to the starting point of his/her ride, or for convenient access to his/her bicycle convenient when an opportunity were to arise, even when a ride had not been planned. Similarly, the user may wish to take his/her bicycle on mass transportation, such as a subway, a train, or on an airplane. A problem also arises when storing the bicycle in a small space. In order to reduce the bicycle space requirement, it should be possible to mount and demount the wheels easily. However, with the current bicycles having the hub mounted on the fork of the frame, mounting and demounting are not practical because of the need to remove and then reposition the chain, and to adjust the braking system, to accommodate the mounting and demounting of the wheel.

The problem of mounting and demounting the wheel also arises in the case of a flat tire. Indeed, to remove the tire from the rim, the wheel must first be demounted from the frame of the bicycle.

In place of conventional forks, there are now bicycles that have a single arm that support the wheel in a cantilever manner. With these so-called single-arm forks, it is easier to mount and demount the wheel, because the wheel is positioned along the axial direction of the hub. Moreover, this manner of connecting a wheel to a frame makes it possible to leave the sprocket cassette and the brake drum or disk on the frame, it not being needed to remove or reposition them when the wheel needs to be removed or mounted upon the frame. Examples of single-arm frames for a bicycle are disclosed in patent documents U.S. Pat. No. 4,170,369, FR 2 611 641, U.S. Pat. No. 2,497,121, and, more recently, EP 1 153 827, and EP 1 147 976. However, the wheels disclosed in these documents are equipped with traction spokes, which requires a hub body or a bell with adequate axial dimension in order to have an acceptable dish angle for the two sets of traction spokes of a wheel.

There are indeed compression spoke wheels or unitary wheels, which have a small space requirement at the base of the compression spokes. Such a wheel is disclosed in the document EP 1 083 063. For these wheels, the hub is centered, or substantially centered, on the radial median plane of the rim. Under these conditions, they could not be used with single-arm forks, as the extent of the overhang would indeed be excessive.

Furthermore, the mass and inertia of these compression-spoke wheels increase with the diameter and, inversely, their rigidity deteriorates with the increase in the diameter. Under these conditions, a 700 mm compression spoke wheel would not be satisfactory with respect to weight and rigidity.

### SUMMARY OF THE INVENTION

An object of the present invention is to provide a new type of bicycle that offers a better compromise between performance and versatility, and which is easier to use than a conventional bicycle.

Other objects and advantages of the invention will become apparent from the description that follows.

The bicycle according to the invention includes a frame defining a general median plane, a front wheel, a rear wheel, and a transmission assembly, the frame having a single-arm front fork and a single-arm rear fork for removably mounting the front and rear wheels, each of the wheels having a rim and a central hub through which it is connected to the frame.

Each of the front and rear wheels has a rim connected to the hub by at least one flexibly and compressively rigid element, this element being asymmetrical with respect to the radial median plane defined by the rim, so that the hub of the wheel is off-centered along an axial direction perpendicular to this plane, while the radial median plane of the rims is merged with the general median plane of the frame.

According to another characteristic of the invention, the diameter of a wheel ranges between 480 and 560 millimeters, or approximately between 480 and 560 millimeters.

According to another characteristic of an embodiment of the invention, the front and rear wheels are identical and, therefore, interchangeable between the front and rear.

According to another characteristic of an embodiment of the invention, the transmission assembly, which includes a crankset, a sprocket cassette associated with the rear wheel, and a transmission chain, is permanently mounted on the frame even during mounting and demounting of the wheels.

At least one flexibly and compressively rigid element of the wheel, according to the invention, connects the rim and the hub, the rigid element being asymmetrical relative to the radial median plane defined by the rim, so that the hub of the wheel is off-centered along an axial direction perpendicular to this plane, while the radial median plane of the rims is merged with the general median plane of the frame.

### BRIEF DESCRIPTION OF THE DRAWINGS

Other characteristics of the invention will become apparent from the description that follows, and from the drawings annexed thereto, in which:

FIG. 1 is a side view of a bicycle according to the invention;

FIG. 2 is a partial cross-sectional view of the frame in the area of the shaft supporting the rear wheel;

FIG. 3 is a partial cross-sectional view of the frame in the area of the shaft supporting the front wheel;

FIG. 4 is a perspective view of a wheel provided for the bicycle of FIG. 1;

FIG. 5 shows the rear wheel and the rear portion of the frame seen along the line V-V referenced in FIG. 1; and

FIG. 6 shows the front wheel and the front fork in the same manner, seen along the line VI-VI referenced in FIG. 1.

### DETAILED DESCRIPTION OF THE INVENTION

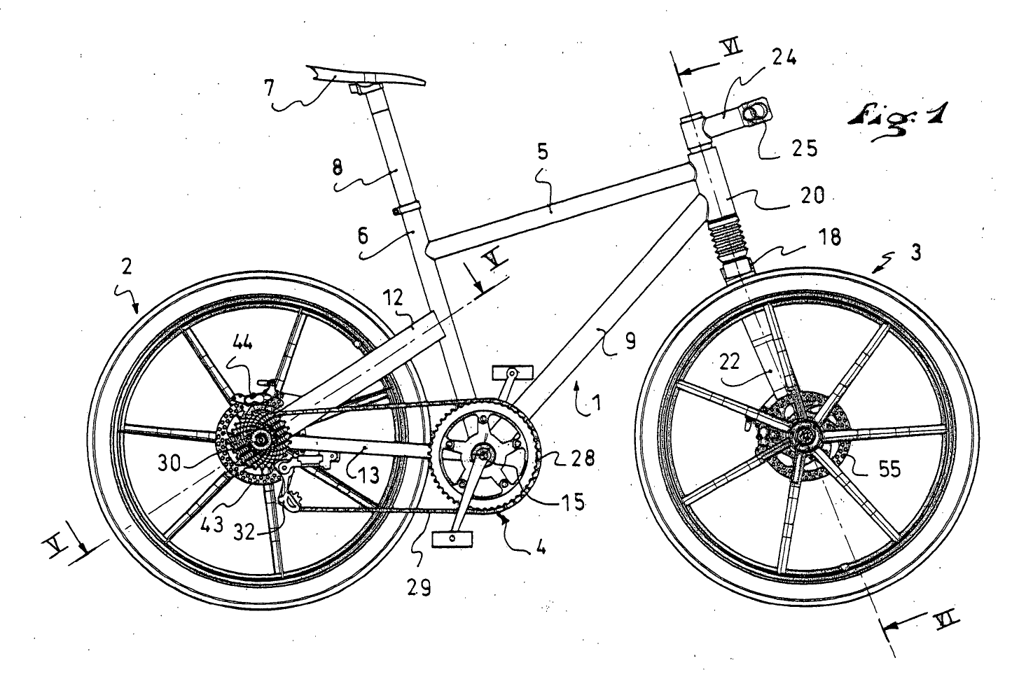

The bicycle illustrated in FIG. 1 includes a frame 1, a rear wheel 2, a front wheel 3, and a transmission assembly 4.

The frame has a base structure 5 formed of tubes or sections assembled to one another by any appropriate means, particularly by welding or by glue/adhesive. The sections or tubes are metallic, made of steel or aluminum alloy, for example. The structure could also be made of a composite material, such as carbon fibers embedded in a resin matrix.

In a known manner, the structure 5 includes a seat tube 6 for supporting the seat 7 and its seat post 8, as well as a down tube 9.

At the rear, the structure 5 has a single-arm wheel-supporting fork. The fork here includes a seat stay 12 and a chain stay 13 that converge toward the center of the rear wheel, on only one side of the wheel.

Conventionally, the chain stay 13 is coupled to the down tube 9 in the area of a crankset case that bears the axis of rotation 15 of the crankset.

At the front, the structure 5 has a head tube 20 to which a fork 18 that carries the front wheel 3 is connected.

The fork 18 has only one arm 22 that passes on only one side of the front wheel 3, extended upward along an axis that crosses the head tube 20, then by a handlebar stem 24 that supports the handlebar 25. In a known manner, the handlebar supports braking and gearshift control levers. These levers and the devices for connecting to the braking and gearshift elements can be of a type known to those skilled in the art and, therefore, they are not shown in the drawing figures.

The frame 1 that has just been described is not intended to limit the invention, other modes of construction also being suitable and encompassed by the invention. In particular, the front fork 18 could be suspended in the area of the arm 22, or in the area of the connection between the axis of the fork 18 and the head tube 20. Similarly for the rear, the seat stay 12 and the chain stay 13 could be connected to the remainder of the structure by a suspension system.

A significant point is that the frame supports the front and rear wheels on only one side of their hubs. The wheels are therefore supported by the frame in a cantilevered manner.

In a manner known to those skilled in the art, the transmission assembly 4 includes a crankset 28, the axle 15 of which is housed in the crankset case, a transmission chain 29 and, at the rear, a sprocket cassette 30.

The crankset shown has only one chainwheel, but this is not limiting; one could also provide a plurality of chainwheels, with one derailleur to pass the chain from one chainwheel to another, or any other variable ratio transmission device such as that described, for example, in the patent documents FR 2 818 952 and US 2004/0029667.

In a known manner, the sprocket cassette 30 includes a plurality of sprockets mounted on a free-wheel body, possibly with an intermediate cage. These elements are described in more detail below. However, a particularity of the sprocket cassette must be noted, in that in the invention it is mounted on the outside of the frame, on the other side of the fork arm that carries the wheel.

The position of the chain on the sprockets is guided by a rear derailleur 32. This derailleur can be of any appropriate type. In the embodiment shown, the derailleur is of the type described in the patent documents EP 0 513 394 and U.S. Pat. No. 5,380,252. Such a derailleur is assembled to a member affixed to the base 13 of the frame and located in front of the axis of the rear wheel. It is well-adapted for the mounting of the sprockets on the outside of the frame.

Other derailleurs could be used with other methods of connection to the frame. Instead of the sprocket cassette and the derailleur, or in addition thereto, a gearshift integrated into the wheel hub or in the crankset could be used.

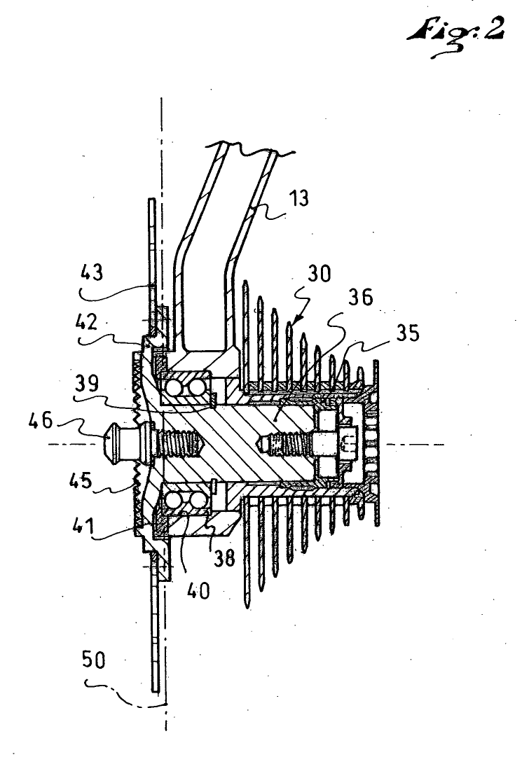

With reference to FIG. 2, the sprocket cassette 30 is engaged on a free wheel body 35, which is itself mounted on one end of the rear wheel shaft 36. A free-wheel mechanism and bearings are positioned between the shaft 36 and the free-wheel body 35 according to a conventional mounting.

The shaft 36 is fitted into the inner cage of a bearing 38. The bearing is housed in an adequately sized housing 40, located at the end of the base 13. According to the embodiment shown, the bearing is retained on the shaft by a circlip 39, and in its housing by a ring 41 assembled to the base. Any other appropriate means could also be used. Preferably, the bearing used is axially compact to reduce the off-centering and to reduce the space requirement; it must also bear substantial radial loads and tilting moments, and must maintain its rigidity with respect to these forces. Therefore, the bearing preferably has two rows of balls with prestressed oblique contacts; it could also have a single row of balls and four contact points, which is even more compact and lighter. One could also use two independent, juxtaposed bearings.

On the side opposite the sprockets, the shaft 36 has a circular flange 42 that provides a shouldered seat for a brake disk 43 and a toothed crown 45 for connection with the wheel.

According to the embodiment shown, the teeth of the crown are circularly distributed about the axis of the shaft, and they have a triangular cross-section and are oriented along an axial direction outward of the shaft. The toothing of the crown is made from the material of the shaft 36 by appropriate machining, for example. The crown ensures a rotational connection between the wheel, which is described below, and the shaft 36.

The disk 43 is fixed to the flange 42 of the shaft by any appropriate means, particularly screws; it cooperates with a braking stirrup 44 of any appropriate type that is mounted on an element affixed to the seat stay 12.

This particular structural arrangement, however, is not limiting; the toothed crown could be affixed to the shaft. Other means of connection between the wheel and the shaft could also be used; for example, a connection by means of a truncated and grooved contact surface could be used, such as that described in the patent document EP 1 153 827. Similarly, the braking stirrup could be mounted differently. Instead of a disk, one could also utilize a drum braking system, or any other appropriate braking system.

At the center of the crown, the shaft 36 is extended outward by a mushroom-shaped end piece 46 provided to fasten the wheel.

As can be noted in FIG. 2, the sprocket cassette, the free-wheel mechanism, and the disk can remain permanently on the frame, particularly when the wheel is demounted. Thus, it is possible to mount and demount the rear wheel without touching the chain or the brake disk.

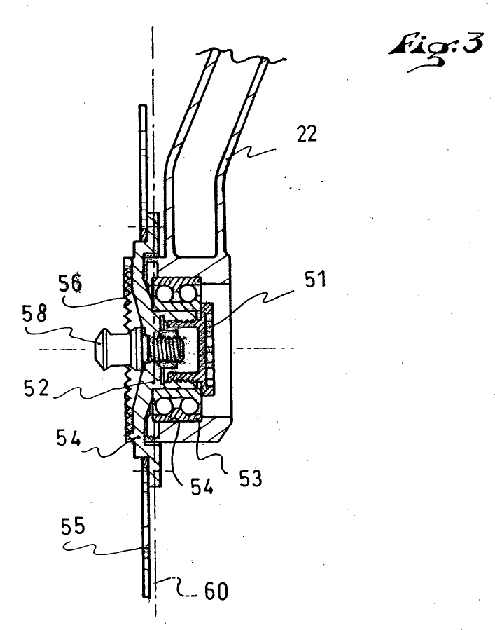

FIG. 3 shows the structure of the front shaft and its connection to the arm 22.

This structure is similar to that of the rear wheel that has just been described; it is simplified, however, due to the absence of sprockets and free-wheel.

As in the preceding case, the shaft 52 is mounted in a bearing 53 that is housed in a housing 54 located at the lower end of the arm 22 of the fork 18. A hollow screw 51 ensures the assembly of the shaft 52 with the inner cage of the bearing 53. Other assembly arrangements are also suitable with the invention.

On one of the sides, the shaft 52 has a flange 54 similar to the flange 42 of FIG. 2, with a shouldered seat for a brake disk 55 and a toothed crown 56 for connecting with the front wheel. At the center of the flange 54, the shaft 52 supports a mushroom-shaped end piece 58 for the assembly of the front wheel.

FIGS. 2 and 3, by means of the broken lines 50 and 60, respectively, schematically show the outline of the median plane defined by the frame.

The toothed crowns 45, 56, and the end pieces 46, 58 are identical, so that the same wheel can be mounted on each of them, as will now be described.

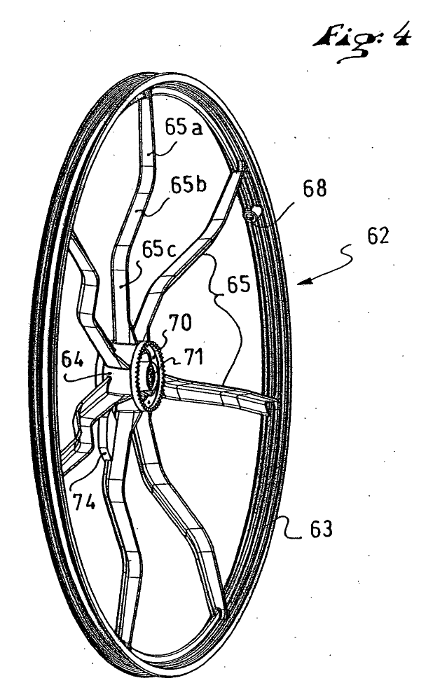

FIG. 4 shows a perspective view of a wheel 62 including a rim 63, a central hub 64, and compression spokes 65 connecting the rim and the hub.

The rim 63 has a shape with an outwardly open annular groove, provided to receive an appropriate tube or a tubeless tire. In the case of a tubeless mounting, the shape of the groove can be consistent with that disclosed in the patent documents EP 0 893 280 and U.S. Pat. No. 6,257,676. The rim has a solid cross-section and, according to the embodiment shown, it has a single bridge with a hole 68 for the passage of the inflation valve.

The compression spokes 65 for connection between the rim and the hub are flexibly and compressively rigid elements. In the embodiment shown, they have a generally L-shaped cross-section and are seven in number; however, this is not limiting. Any other appropriate cross-section and number of compression spokes are also suitable according to the invention.

The hub has a toothed crown 70 that is provided to cooperate with either one of the crowns 45 and 56, a central barrel 71 closing a device for the automatic tightening of the hub on either one of the end pieces 46, 58. This mechanism is provided to cooperate with the end pieces. It has not been described in further detail and can be, for example, of the same type as that described in the previously mentioned patent document EP 1 153 827. It is maneuvered by means of a lever 74. The crown 70 is attached on the hub; it could also be made as one-piece therewith.

The arrangement of the teeth that are axially oriented ensures a good centering of the wheel on its shaft.

The wheel can be made out of any appropriate material by injection molding, for example. As an example, the wheel can be made of a plastic material, a fiber-reinforced plastic, aluminum alloy, magnesium alloy, or any other appropriate material.

According to the embodiment shown, the wheel is a one-piece wheel, with the exception of the crown and the tightening mechanism that are attached. This is not limiting; the various elements of the wheel could be manufactured separately and then assembled by screws, rivets, welding, or glue/adhesive.

A particularity of the wheel lies in that the hub is off-centered along an axial direction so as to be entirely located on only one side of the radial median plane defined by the rim. The axial off-centering of the hub is done in relation to the construction of the front and rear shafts and of their associated elements, so that the median plane of the rims coincides with the median plane of the frame. The outline of this plane in the plane of FIGS. 2 and 3 is schematically shown by the broken lines 50, 60.

As can be seen in FIG. 4, the compression spokes 65 have an asymmetrical configuration relative to the radial median plane of the rim; they are made of three portions; a radially oriented distal portion 65a, an inclined intermediate portion 65b parallel to the generatrix of a truncated cone centered on the axle of the wheel, and a radially oriented proximal portion 65c. This is not limiting; the compression spokes could have another shape, provided that they have a portion that is non-parallel to the radial median plane of the rim, so as to bring a lateral off-centering of the hub relative to the rim along an axial direction. Having rigid compression spokes and not traction spokes, as used in conventional bicycles, makes it possible to obtain the lateral off-centering of the hub with a minimal axial space requirement. In the present case, the compression spokes are all off-centered on the same side of the radial median plane of the rim. Traction spokes would require maintaining two sets of spokes, i.e., one located on each of the sides of the median plane in order to preserve the balance of forces in the area of the rim.

According to a characteristic of the illustrated embodiment of the invention, the wheels of the bicycle have an outer diameter between 480 and 560 millimeters, and, in a particular embodiment, approximately 520 millimeters. This represents a diameter of about 507 millimeters in the area of the rim bead seat.

Such a diameter has been found to offer a good compromise between the various qualities required for a wheel.

Tests have shown that within the aforementioned diameter range, a wheel has good qualities in terms of road performance and obstacle clearance. Moreover, as the diameter of the wheel is relatively reduced, the weight of the wheel and, therefore, its inertia, are relatively low, considering its rigidity.

According to another characteristic of the invention, the front and rear wheels are identical and interchangeable. In this case, the automatic tightening mechanisms at the front and rear are identical.

It must be noted that the wheels themselves do not have any rotationally movable axle or element, with the exception of the tightening mechanism. Indeed, all of the rotationally movable parts are permanently mounted on the frame.

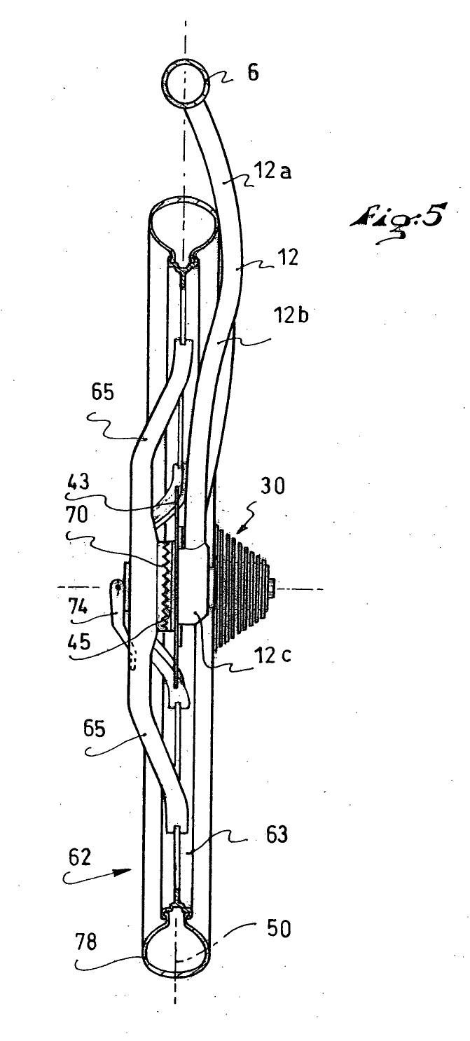

FIG. 5 schematically shows the wheel 62 mounted on the rear shaft. On the side of the frame, the sprocket cassette 30, the brake disk 43, and the seat stay 12 can be seen.

On the side of the wheel 62, the rim 63 is shown with a tire 78 and compression spokes 65.

The assembly between the wheel and the frame occurs by mutual engagement of the teeth of the two crowns 45 and 70 which ensure a rotational coupling, and by the tightening device that ensures the axial coupling.

As can be seen in FIG. 5, the seat stay 12 extends from the seat tube 6 outward in a first portion 12a in order to extend around the tire; then it extends inward in a second portion 12b. A third portion 12c of the seat stay 12, the one that carries the bearing of the shaft, is parallel to the median plane of the frame and of the rim. The chain stay 13 is shaped in a similar manner in order to extend around the tire and come back toward the general median plane of the frame.

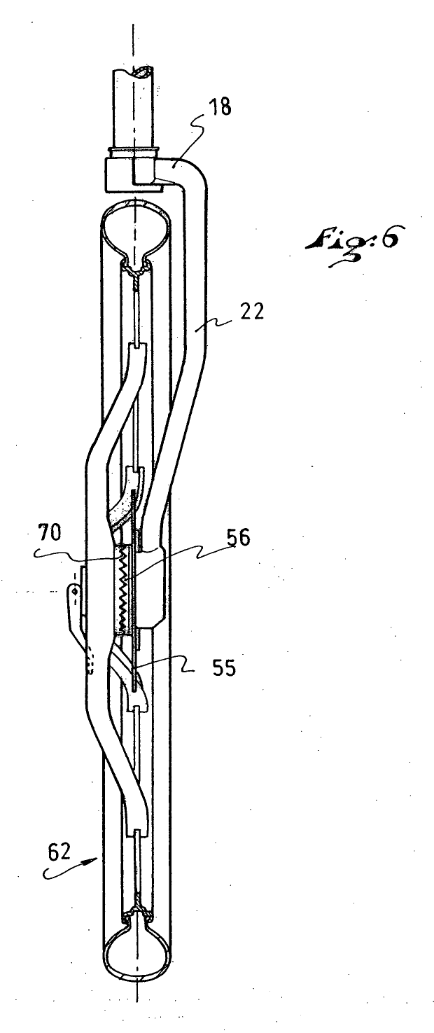

FIG. 6 shows the wheel 62 in the same manner, mounted at the front on the fork. This drawing figure shows that the single arm 22 of the fork 18 is shaped to extend around the tire, and then to come back toward the general median plane of the frame. The rotational coupling is done by means of the toothed crowns 56 and 70, and the axial tightening by means of the tightening device borne by the wheel.

The arrangement of these front and rear assemblies relative to the general median plane defined by the frame is determined in the following manner.

First, the axial position of the sprocket cassette is determined to respect the chain line, i.e., an average alignment of the chain with the set of sprockets. Generally, the plane defined by the toothed crown of the chainwheel passes toward the center of the cassette. Next, the space requirement of the bearing 38 and its housing in the base 13 are taken into account. Finally, the space requirement of the disk and its brake stirrup are taken into account.

The chain stay and the seat stay are therefore curved or bent somewhat, so that the sprocket cassette is centered on the chain line defined by the chainwheel. Under these conditions, the brake disk and the bearing are very close to the general median plane of the frame, on both sides thereof.

At the front, the disk 55, the toothed crown 56, and the end piece 58 are located at the same distance from this plane as these same elements from the rear portion. FIG. 1 shows that the chain stay 13 and the front fork arm 22 are located on opposite sides of the wheels. Under these conditions, the elements mentioned hereinabove are located on opposite sides of the median plane in a symmetrical configuration relative to this plane.

The present description is only provided by way of example; other embodiments of the invention could be adopted without leaving the scope of the invention.

In particular, wheels having a diameter different from that mentioned above could be used at the front and at the rear and, further, the diameter of the front wheel can be different from that of the rear wheel. Instead of a connection of the rim and of the hub by means of compression spokes, one could have a connection by a disk or disk portions, i.e., a solid disk or a solid disk interrupted by openings, or any other flexibly and compressively rigid element.

1. A bicycle comprising:
a frame defining a general median plane;
a front wheel and a rear wheel;
a transmission assembly;
the frame having a front single-arm fork and rear single-arm fork for removably mounting the front and rear wheels, respectively;
each of the wheels comprising a rim and a central hub, the central hub of each of the wheels connecting the wheels to the frame;
each of the wheels further comprising at least one flexibly rigid and compressively rigid element connecting the central hub and the rim, each of said flexibly and compressively rigid element being asymmetrical with respect to a radial median plane defined by the rim, so that the hub of each said wheel is off-centered along an axial direction perpendicular to said radial median plane;
the radial median plane of each of the rims of said wheels coincides with the general median plane of the frame.

2. A bicycle according to claim 1, wherein:
the rim of each of the front and rear wheels has an outer diameter between 480 and 560 millimeters.

3. A bicycle according to claim 1, wherein:
the rim of each the front and rear wheels has an outer diameter of approximately 520 millimeters.

4. A bicycle according to claim 1, wherein:
the rim and the hub of each of the front and rear wheels are connected by rigid compression spokes, at least one portion of said spokes being non-parallel with the radial median plane defined by the rim.

5. A bicycle according to claim 1, wherein:
the front and rear wheels are identical and interchangeable.

6. A bicycle according to claim 1, wherein:
each of the front and rear forks includes a housing;
each of the front and rear wheels is supported by a shaft positioned in a respective one of said housings.

7. A wheel for a bicycle, said wheel comprising:
a rim defining a radial median plane, said median plane adapted to coincide with a median plane of a frame of the bicycle;
a hub adapted to be mounted to the frame of the bicycle for rotation with respect to the frame; and
at least one rigid element connecting the rim and the hub;
said rigid element being asymmetrical with respect to the radial median plane defined by the rim to off-center the hub along an axial direction perpendicular to the radial median plane of the rim, while the radial median plane of the rim coincides with the median plane of the frame when the hub of the wheel is mounted upon the frame.

8. A wheel for a bicycle according to claim 7, wherein:
the rim has an outer diameter in a range of between 480 and 560 millimeters.

9. A wheel for a bicycle according to claim 8, wherein:
the rim has an outer diameter of approximately 520 millimeters.

10. A wheel for a bicycle according to claim 7, wherein:
the rim and the hub are connected by rigid compression spokes, at least one portion of each of said spokes is non-parallel to the median plane defined by the rim.

11. A wheel for a bicycle according to claim 10, wherein:
said rigid compression spokes are seven in number.

12. A wheel for a bicycle according to claim 7, wherein:
said rim, said hub, and said rigid element connecting said rim and said hub are made in one piece.

13. A wheel for a bicycle according to claim 12, wherein:
said wheel comprises aluminum or magnesium alloy.

14. A wheel for a bicycle according to claim 7, wherein:
the rim has a shape provided for mounting a tubeless tire.

15. A wheel for a bicycle according to claim 7, further comprising:
a device for rotational coupling of the wheel to the frame of the bicycle and a device for axial tightening of the wheel to the frame of the bicycle.
